(19) United States
(12) Patent Application Publication
(10) Pub. No.: US 2012/0057355 A1
(43) Pub. Date: Mar. 8, 2012

(54) Lamp Assembly

(75) Inventor: Duan-Cheng HSIEH, Taipei City (TW)

(73) Assignee: HABITEX CORPORATION, Taipei City (TW)

(21) Appl. No.: 12/875,567

(22) Filed: Sep. 3, 2010

(51) Int. Cl. F21V 1/00

(52) U.S. Cl. 362/351

(57) ABSTRACT

A lamp assembly includes a connecting member interconnecting a support member and a lampshade member. The lampshade member includes a shade body, and a housing body adapted for mounting of and connecting electrically with a light source. The housing body has a shade-engaging end connected removably to the shade body, and further has opposite lateral parts, each formed with a slit that has an opening formed in the shade-engaging end. The connecting member has a support-coupling portion connected to the support member, and a fork portion with a pair of branches. The housing body is disposed between the branches, and the branches engage removably and respectively the slits in the housing body.

### BACKGROUND OF THE INVENTION

1. Field of the Invention

The invention relates to a lamp assembly, more particularly to a lamp assembly that includes a connecting member interconnecting a support member and a lampshade member.

2. Description of the Related Art

A support member and a lampshade of a conventional lamp assembly are generally assembled with the use of screw fasteners. Assembly and disassembly of the conventional lamp assembly is thus inconvenient and time-consuming due to the need to fasten and unfasten screws with the use of a screwdriver. Moreover, the screw fasteners increase the cost of the lamp assembly.

### SUMMARY OF THE INVENTION

The object of the present invention is to provide a lamp assembly that can be assembled and disassembled quickly with relative ease.

According to this invention, a lamp assembly includes a support member, a lampshade member, and a connecting member. The lampshade member includes a shade body, and a housing body adapted for mounting of and connecting electrically with a light source. The housing body has a shade-engaging end connected removably to the shade body, and further has opposite lateral parts, each formed with a slit that has an opening formed in the shade-engaging end. The connecting member has a support-coupling portion connected to the support member, and a fork portion with a pair of branches. The housing body is disposed between the branches, and the branches engage removably and respectively the slits in the housing body.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic side view of the first preferred embodiment of a lamp assembly according to the present invention;

FIG. 2 is a partly exploded schematic side view of the first preferred embodiment;

FIG. 3 is a fragmentary view of the first preferred embodiment for illustrating connection between a housing body and a shade body and engagement between the housing body and a fork portion;

FIG. 4 is a sectional view of the first preferred embodiment for illustrating a power cord that extends through a cord groove of a connecting member;

FIG. 5 is a fragmentary partly sectional view of the first preferred embodiment for illustrating the power cord extending through a cord groove of a support-coupling portion;

FIG. 6 is a schematic side view of a modification of the first preferred embodiment;

FIG. 7 is a schematic side view of the second preferred embodiment of a lamp assembly according to the present invention;

FIG. 8 is a schematic side view of the third preferred embodiment of a lamp assembly according to the present invention; and

FIG. 9 is a schematic side view of the fourth preferred embodiment of a lamp assembly according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

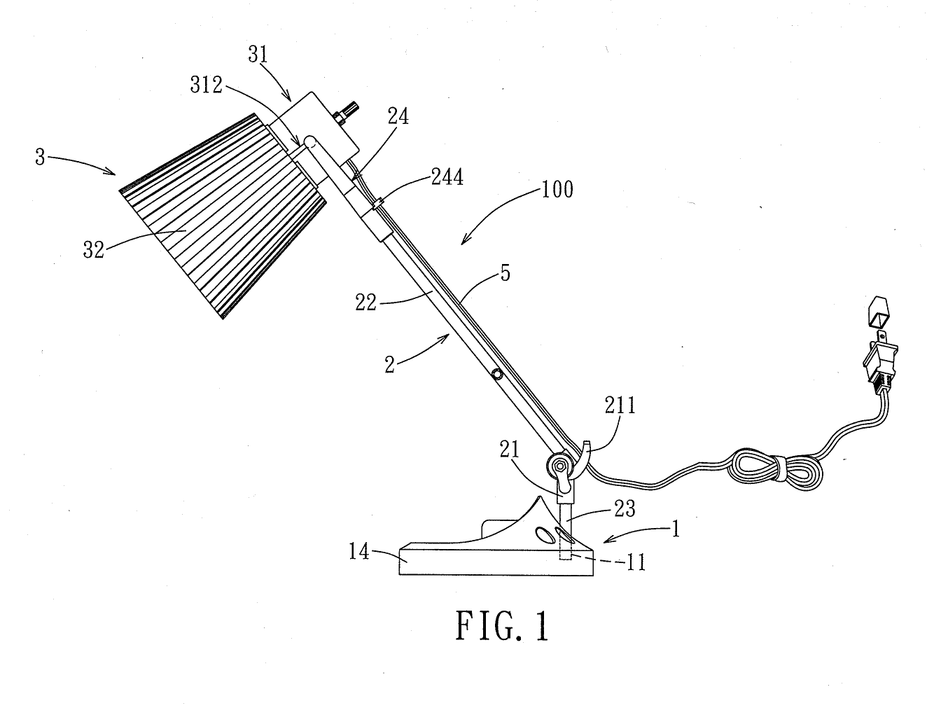

Referring to FIGS. 1 to 3, the first preferred embodiment of a lamp assembly 100 according to the present invention is shown to include a support member 1, a connecting member 2, and a lampshade member 3. The connecting member 2 interconnects the support member 1 and the lampshade member 3.

The lampshade member 3 includes a shade body 32, and a housing body 31 adapted for mounting of and connecting electrically with a light source 4. The housing body 31 has a shade-engaging end 311 connected removably to the shade body 32, and further has opposite lateral parts, each formed with a slit 312 that has an opening 313 formed in the shade-engaging end 311.

The connecting member 2 has a support-coupling portion 21 connected to the support member 1, and a fork portion 24 with a pair of branches 241. The housing body 31 is disposed between the branches 241. The branches 241 engage removably and respectively the slits 312 in the housing body 31.

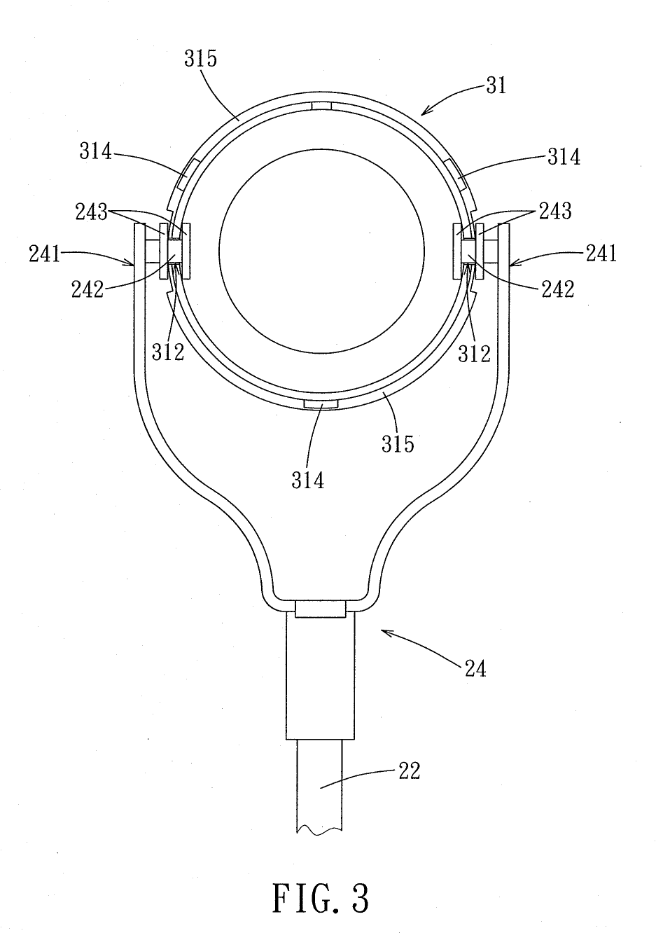

As shown in FIG. 3, in this embodiment, each of the branches 241 of the fork portion 24 includes a shaft 242 extending into the respective one of the slits 312 in the housing body 31. The housing body 31 is pivotable about the shafts 242 of the branches 241 of the fork portion 24 so as to permit adjustment of an illuminated area of the lamp assembly.

In addition, each of the shafts 242 of the branches 241 of the fork portion 24 has a flange 243 formed thereon, and the flanges 243 of the shafts 242 abut against one of inner and outer sides of the housing body 31. In this embodiment, each of the shafts 242 has two flanges 243, one of which abuts against the inner side of the housing body 31 while the other one of which abuts against the outer side of the housing body 31. By virtue of the flanges 243 that abut against the housing body 31, relative movement between the housing body 31 and the shafts 242 along the axis of the shafts 242 can be prevented so as to ensure secure engagement between the branches 241 of the fork portion 24 and the housing body 31.

In this embodiment, the connecting member 2 further includes a connecting arm 22 having one end connected pivotally to the support-coupling portion 21 and an opposite end provided with the fork portion 24. The support-coupling portion 21 includes an insert rod 23 that extends downwardly.

In this embodiment, the support member 1 includes a base 14 formed with an engaging hole 11 that opens upwardly. The insert rod 23 of the support-coupling portion 21 of the connecting member 2 is inserted removably into the engaging hole 11, i.e., the connecting member 2 is connected removably to the support member 1. The base 14 is suitable for placing on a desktop or a flat surface. Preferably, the base 14 has a disc-shape.

In this embodiment, the housing body 31 includes a plurality of first engaging blocks 314 extending from the outer side thereof proximate to the shade-engaging end 311. The housing body 31 further includes a pair of second engaging blocks 315 extending from the outer side thereof and spaced apart from the first engaging blocks 314 along an axial direction of the housing body 31. The shade body 32 has one end formed with an engaging ring 321 to be sleeved on the housing body 31 and retained removably between the first engaging blocks 314 and the second engaging blocks 315.

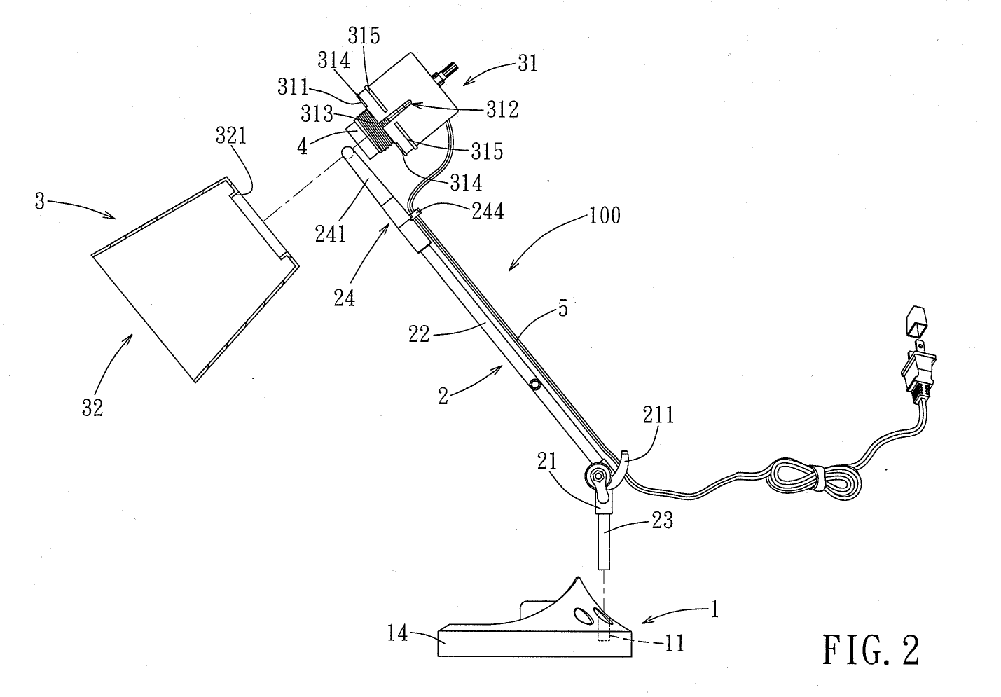

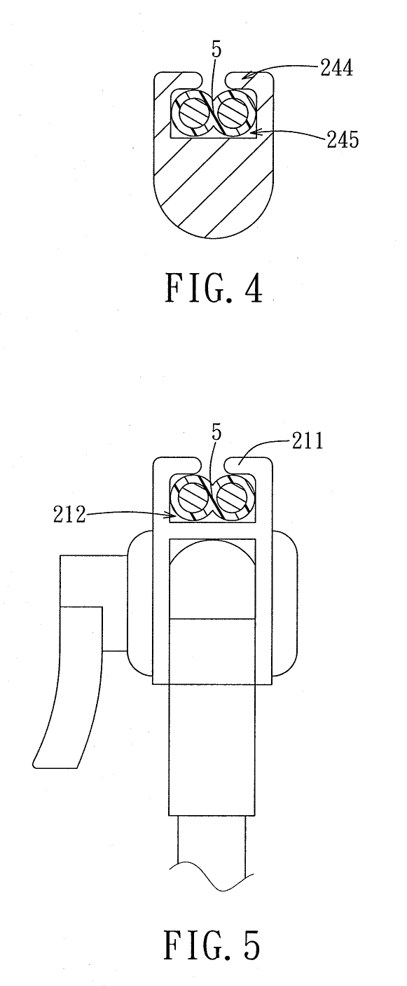

As shown in FIGS. 4 and 5, the connecting member 2 preferably includes a cord hooking portion 244 formed with a cord groove 245 that is adapted for retaining removably a power cord 5. The power cord 5 is coupled electrically to the light source 4 (see FIG. 2). The support-coupling portion 21 of the connecting member 2 likewise includes a cord hooking portion 211 formed with a cord groove 212 that is adapted for retaining removably the power cord 5. Accordingly, the power cord 5 may be orderly arranged to extend along the connecting member 2.

Referring to FIGS. 1 to 5, to assemble the lamp assembly 100, the insert rod 23 of the connecting member 2 is first inserted into the engaging hole 11. Next, the shaft 242 of each of the branches 241 is extended through the corresponding opening 313 for engaging the corresponding one of the slits 312 in a manner that the housing body 31 is disposed between the branches 241 of the connecting member 2. The engaging ring 321 is subsequently retained between the first engaging blocks 314 and the second engaging blocks 315 so as to mount the shade body 32 on the housing body 31. The shafts 242 are prevented from escaping from the slits 312 through the openings 313 at this time. Finally, the power cord 5 is extended through the cord groove 245 of the fork portion 24 and the cord groove 212 of the support-coupling portion 21 in sequence, thereby completing the assembly operation of the lamp assembly 100.

To disassemble the lamp assembly 100, first the power cord 5 is removed from the cord groove 245 and the cord groove 212. Next, the engaging ring 321 is disengaged from between the first engaging blocks 314 and the second engaging blocks 315 so that the shafts 242 can be removed from the slits 312 through the openings 313, thereby removing the housing body 31 from the branches 241. Finally, the insert rod 23 is removed from the engaging hole 11 to complete the disassembly operation of the lamp assembly 100. The assembly and disassembly operations may be easily and quickly performed, since screwdrivers or other tools are not needed for these operations.

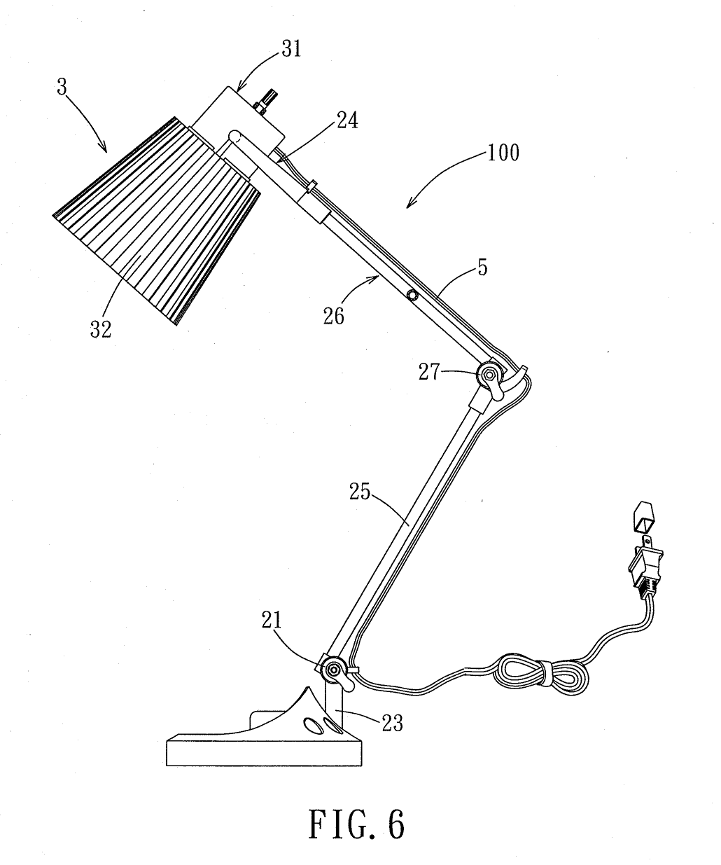

As shown in FIG. 6, in one possible modification of the lamp assembly 100, the connecting member 2 may include a first connecting arm 25 provided with the support-coupling portion 21, a second connecting arm 26 formed with the fork portion 24, and a pivot joint 27 interconnecting the first and second connecting arms 25, 26. This modification permits adjustment of the height of the light source 4 (see FIG. 2).

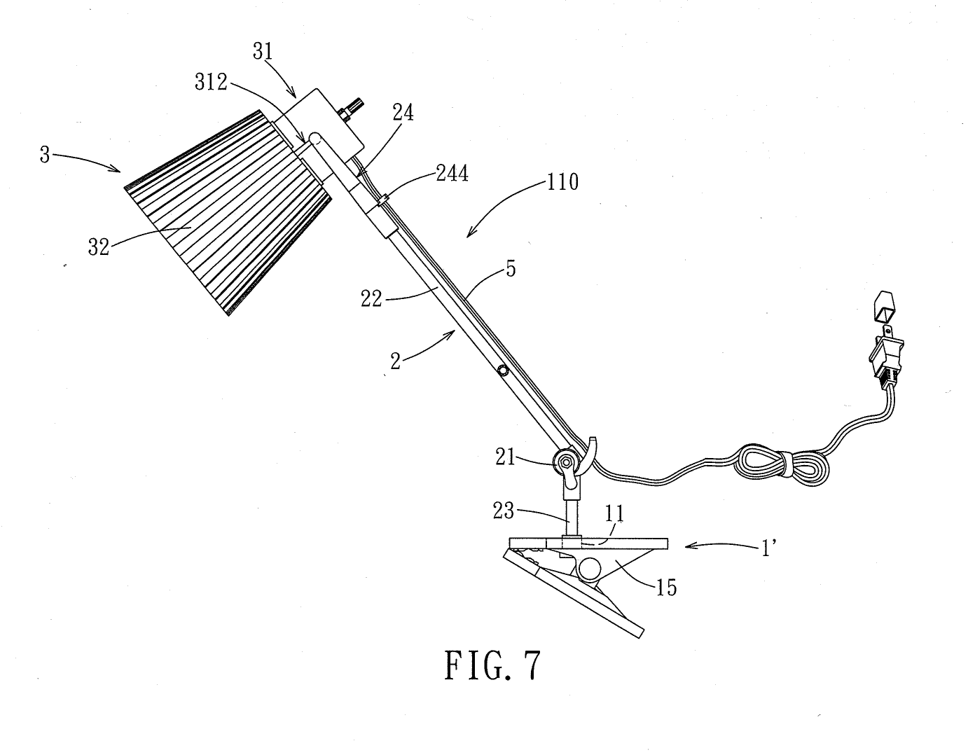

Referring to FIG. 7, the second preferred embodiment of the lamp assembly 110 according to the present invention is generally similar to the first preferred embodiment in structure, and differs in that the support member 1′ includes a clamp 15 formed with an engaging hole 11. The insert rod 23 of the support-coupling portion 21 of the connecting member 2 is inserted removably into the engaging hole 11. The clamp 15 is used for clamping an edge of a desk or a wall (not shown), and enhances flexibility in using the lamp assembly 110.

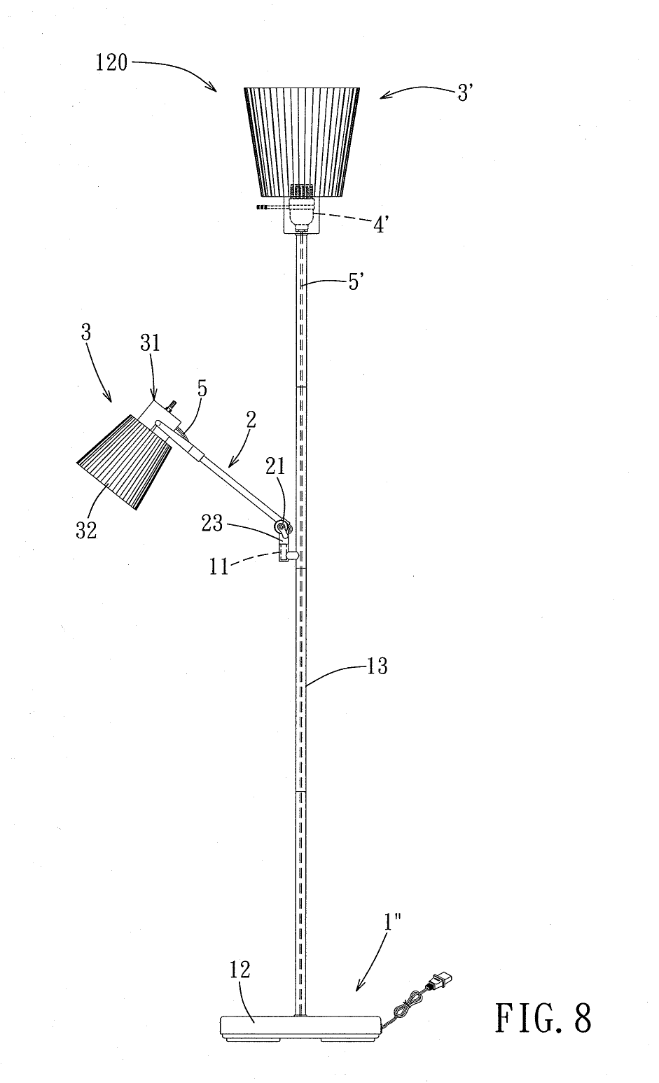

Referring to FIG. 8, the third preferred embodiment of the lamp assembly 120 according to the present invention is generally similar to the first preferred embodiment in structure, and differs in that the support member 1″ includes a base 12 and a post 13 extending upwardly from the base 12. The insert rod 23 of the support-coupling portion 21 is inserted removably into an engaging hole 11 formed in a middle part of the post 13. Another lampshade member 3′ is mounted on top of the post 13. Another power cord 5′ extends through the post 13, is connected in parallel with the power cord 5, and is coupled electrically to a light source 4′ mounted in the lampshade member 3′.

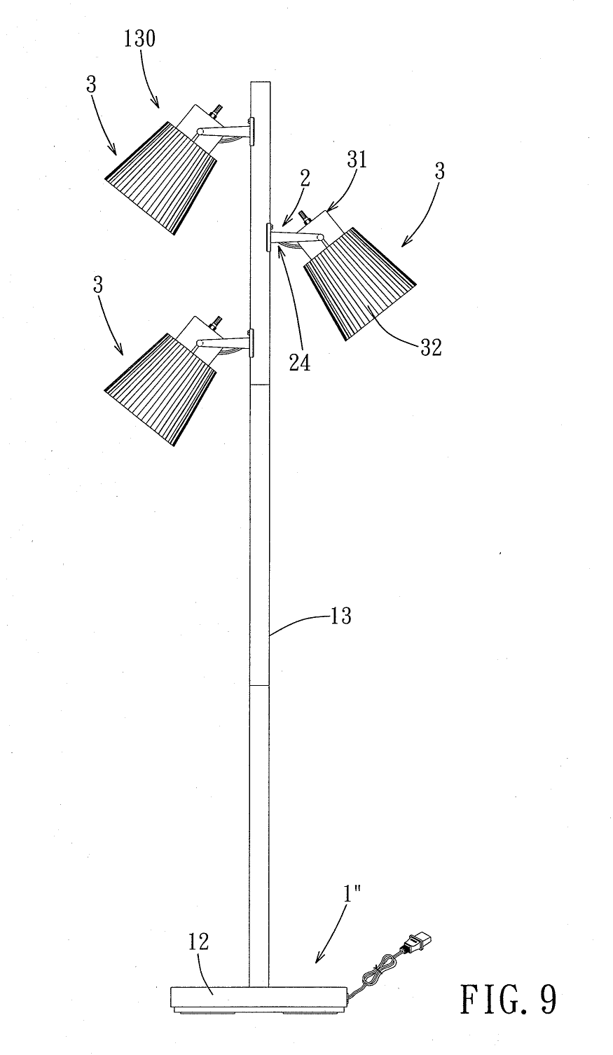

Referring to FIG. 9, the fourth preferred embodiment of the lamp assembly 130 according to the present invention is generally similar to the third preferred embodiment in structure, and differs in that the lamp assembly 130 includes a plurality of lampshade members 3 mounted at different heights of the post 13 through the fork portions 24 of respective connecting members 2. The connecting members 2 are connected removably to the post 13 in a manner that the lamp assembly 130 has a lamp tree configuration.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lamp assembly comprising:
a support member;
a lampshade member including a shade body, and a housing body adapted for mounting of and connecting electrically with a light source, said housing body having a shade-engaging end connected removably to said shade body, and further having opposite lateral parts, each formed with a slit that has an opening formed in said shade-engaging end; and
a connecting member having a support-coupling portion connected to said support member, and a fork portion with a pair of branches, said housing body being disposed between said branches, said branches engaging removably and respectively said slits in said housing body.

2. The lamp assembly as claimed in claim 1, wherein each of said branches of said fork portion includes a shaft extending into the respective one of said slits in said housing body.

3. The lamp assembly as claimed in claim 2, wherein said housing body is pivotable about said shafts of said branches of said fork portion.

4. The lamp assembly as claimed in claim 3, wherein each of said shafts of said branches of said fork portion has a flange formed thereon, said flanges of said shafts abutting against one of inner and outer sides of said housing body.

5. The lamp assembly as claimed in claim 2, wherein each of said shafts of said branches of said fork portion has a flange formed thereon, said flanges of said shafts abutting against one of inner and outer sides of said body.

6. The lamp assembly as claimed in claim 1, wherein said connecting member includes a cord hooking portion formed with a cord groove that is adapted for retaining removably a power cord.

7. The lamp assembly as claimed in claim 1, wherein said connecting member includes a first connecting arm provided with said support-coupling portion, a second connecting arm provided with said fork portion, and a pivot joint interconnecting said first and second connecting arms.

8. The lamp assembly as claimed in claim 1, wherein said support member includes a base formed with an engaging hole, said support-coupling portion of said connecting member being inserted removably into said engaging hole.

9. The lamp assembly as claimed in claim 1, wherein said support member includes a clamp formed with an engaging hole, said support-coupling portion of said connecting member being inserted removably into said engaging hole.

10. The lamp assembly as claimed in claim 1, wherein said support member includes a base and a post extending upwardly from said base, said support-coupling portion being connected removably to said post.
